(19) United States
(12) Patent Application Publication
(10) Pub. No.: US 2005/0099449 A1
(43) Pub. Date: May 12, 2005

(54) Methods and structures for disassembling inkjet printhead components and control therefor

(76) Inventors: Tim Frasure, Georgetown, KY (US); James A. Kerr, Lexington, KY (US); Steven R. Komplin, Lexington, KY (US); Paul T. Spivey, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/704,427

(22) Filed: Nov. 7, 2003

(51) Int. Cl. B41J 2/015

(52) U.S. Cl. 347/20; 29/890.1

(57) ABSTRACT

Methods for disassembling at least two components of an inkjet printhead include applying heat, preferably in the form of laser energy, to one of the components and wholly or partially separating the components thereafter. The disassembly enables ease of refilling the inkjet printhead or replacing original parts. In one embodiment, the components comprise inkjet printhead lids and bodies originally laser welded to one another. In another aspect, methods of disassembly include laser unwelding inkjet printhead lids and bodies according to whether the inkjet printhead body embodies a mono or color ink body type through use of selective control of one or more laser light sources to illuminate the inkjet printhead lid in a specific pattern of light. Still other aspects include a disassembled inkjet printhead having components with laser welding residue thereon. The laser welding residue may have substantially matching edge lines between the two components.

### FIELD OF THE INVENTION

The present invention relates to disassembling inkjet printhead components for repair or refilling with ink. In one aspect, it relates to disassembling inkjet printhead lids and bodies laser welded to one another. In another aspect, it relates to application of laser energy and whole or partial separation of components. In still other aspects, it relates to selective application of laser light control according to inkjet printhead body-type. Disassembled inkjet components containing laser welding residue material are also taught.

### BACKGROUND OF THE INVENTION

The art of laser welding is relatively well known. In general, with reference to FIG. 1, first and second work pieces, embodied as an upper work piece 100 laid on a lower work piece 120 along a weld interface 180, become welded to one another by way of an irradiated beam 140 of laser light. As is known, the beam 140 passes through the upper work piece, which is laser light translucent or transparent, and gets absorbed by the lower work piece, which is generally opaque to laser light. As the beam irradiates, the weld interface heats up and causes the bottom surface of the upper work piece and the upper surface of the lower work piece to melt and meld together. Upon cooling, a weld joint remains.

An optical path between a laser light source (not shown) and the to-be-welded work pieces may include a lens 160, for proper focusing, or other optical elements, such as mirrors, fiber optic strands, scanning structures or other. A clamping device (not shown) typically provides a pressing engagement of the work pieces to maintain relative positioning and good surface contact. The beam may weld as an advancing beam of light during contour welding (embodied as either the beam of light moving relative to stationary work pieces, work pieces moving relative to a stationary beam or both moving relative to one another) or as a simultaneous weld (embodied as an entirety of a weld interface being welded at the same time by a light beam with substantially no movement of the work pieces or beam).

Regarding the technology of inkjet printheads and printing, it too is relatively well known. In general, an image is produced by emitting ink drops from an inkjet printhead at precise moments such that they impact a print medium, such as a sheet of paper, at a desired location. The printhead is supported by a movable print carriage within a device, such as an inkjet printer, and is caused to reciprocate relative to an advancing print medium and emit ink drops at such times pursuant to commands of a microprocessor or other controller. The timing of the ink drop emissions corresponds to a pattern of pixels of the image being printed. Other than printers, familiar devices incorporating inkjet technology include fax machines, all-in-ones, photo printers, and graphics plotters, to name a few.

A conventional thermal inkjet printhead includes access to a local or remote supply of color or mono ink, a heater chip, a nozzle or orifice plate attached to the heater chip, and an input/output connector, such as a tape automated bond (TAB) circuit, for electrically connecting the heater chip to the printer during use. The heater chip, in turn, typically includes a plurality of piezoelectric elements or thin film resistors or heaters fabricated by deposition, masking and etching techniques on a substrate such as silicon.

To print or emit a single drop of ink, an individual heater is uniquely addressed with a small amount of current to rapidly heat a small volume of ink. This causes the ink to vaporize in a local ink chamber (between the heater and nozzle plate) and be ejected through the nozzle plate towards the print medium.

During manufacturing of the printheads, a printhead body gets stuffed with a back pressure device, such as a foam insert, and saturated with mono or color ink. A lid adheres or welds to the body via ultrasonic vibration. Ultrasonic welding, however, often cracks the heater chip, introduces and entrains air bubbles in the ink and compromises overall printhead integrity. Adhering has an impractically long cure time. Thus, some printhead manufacturers may turn to laser welding to reliably and consistently manufacture a printhead without causing cracking of the ever valuable heater chip.

No matter the manufacturing technique, the market of refilling and repairing inkjet printheads has become quite commonplace. To this end, the art has need for effective disassembly techniques of inkjet printheads, facilitating repair and refilling, that can accommodate various manufacturing processes, especially those involving forward-looking laser welding.

### SUMMARY OF THE INVENTION

The above-mentioned and other problems become solved by applying the principles and teachings associated with the hereinafter described methods, structures and control for disassembling inkjet printhead components.

Methods for disassembling at least two components of an inkjet printhead include applying heat to one of the components and wholly or partially separating the components thereafter. The disassembly enables ease of refilling the inkjet printhead or replacing original parts. In one embodiment, the components comprise inkjet printhead lids and bodies originally laser welded to one another and the application of heat occurs via laser energy. The laser energy source may include a system that originally welded the inkjet lid to body through a first instance of laser energy at a weld interface between the lid and body.

Since mono ink and color ink inkjet printheads have various constructions, methods of disassembly further contemplate laser “unwelding” inkjet printhead lids from bodies according to whether the body type of the inkjet printhead body corresponds to a mono or color ink type. It also contemplates selective control of one or more laser light sources to illuminate the inkjet printhead lid in a specific pattern of light. In some instances the light pattern comprises illumination of a laser light about a periphery of the lid. In other instances, the light pattern comprises illumination of the laser light about a periphery plus interior of the lid. The invention even contemplates control for one or more laser light sources.

Still other aspects of the invention include a disassembled inkjet printhead having components with laser welding residue thereon. In one embodiment, laser welding residue resides on an undersurface of an inkjet printhead lid and an upper surface of an inkjet printhead body. It also occurs in a substantially non-uniform or irregular thickness. The laser welding residue may have substantially matching edge lines between the two components that can become realigned with one another back into their original alignment to facilitate inkjet printhead reassembly.

After disassembly, the invention contemplates refilling or repair of the inkjet printhead and reassembly. The refilling includes adding ink from a source external to the printhead. The reassembly includes welding the original lid and body back together or replacing the lid with a new lid and welding it to the original body. Welding techniques preferably include laser welding but may additionally include ultrasonic or other. Still further, the invention discloses inkjet printers that contain the refilled or repaired inkjet printheads.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1 is a diagrammatic view in accordance with the prior art of two work pieces being laser welded together;

FIG. 2A is a diagrammatic view in accordance with the teachings of the present invention of an assembled inkjet printhead requiring disassembly;

FIG. 2B is a diagrammatic view in accordance with the teachings of the present invention of the assembled inkjet printhead having heat energy in the form of laser energy being applied to the inkjet printhead;

FIG. 2C is a diagrammatic view in accordance with the teachings of the present invention of a disassembled inkjet printhead;

FIG. 2D is a diagrammatic view in accordance with the teachings of the present invention of a disassembled inkjet printhead being refilled;

FIG. 3A is a diagrammatic view in accordance with the teachings of the present invention of one embodiment of a structure facilitating whole or partial separation of two inkjet printhead components;

FIG. 3B is a diagrammatic view in accordance with the teachings of the present invention of an alternate embodiment of a structure facilitating whole or partial separation of two inkjet printhead components;

FIG. 3C is a diagrammatic view in accordance with the teachings of the present invention of an alternate embodiment of a structure facilitating whole or partial separation of two inkjet printhead components;

FIG. 3D is a diagrammatic view in accordance with the teachings of the present invention of an alternate embodiment of a structure facilitating whole or partial separation of two inkjet printhead components;

FIG. 4A is a diagrammatic view in accordance with the teachings of the present invention of a disassembled inkjet printhead having partial separation of inkjet printhead components;

FIG. 4B is a diagrammatic view in accordance with the teachings of the present invention of a disassembled inkjet printhead having partial separation of inkjet printhead components;

FIG. 4C is a diagrammatic view in accordance with the teachings of the present invention of a disassembled inkjet printhead having partial separation of inkjet printhead components;

FIG. 5A is a diagrammatic top view of an upper surface of a mono inkjet printhead body requiring laser unwelding;

FIG. 5B is a diagrammatic top view of an upper surface of a color inkjet printhead body requiring laser unwelding;

FIG. 6A is a diagrammatic view of a bank of laser beam fiber optic bundles controlled for laser unwelding the mono inkjet printhead body of FIG. 5A;

FIG. 6B is a diagrammatic view of another bank of laser beam fiber optic bundles controlled, together with the bank of laser beam fiber optic bundles of FIG. 6A, for laser unwelding the color inkjet printhead body of FIG. 5B;

FIG. 7A is a diagrammatic view of a first embodiment of a laser welding structure for controlling the banks of laser beam fiber optic bundles of FIGS. 6A and 6B during an unwelding operation of an inkjet printhead lid and body;

FIG. 7B is a diagrammatic view of a second embodiment of a laser welding structure for controlling the banks of laser beam fiber optic bundles of FIGS. 6A and 6B during an unwelding operation of an inkjet printhead lid and body;

FIG. 8 is a perspective view in accordance with the teachings of the present invention of a repaired or refilled inkjet printhead; and

FIG. 9 is a perspective view in accordance with the teachings of the present invention of an inkjet printer for housing a repaired or refilled inkjet printhead.

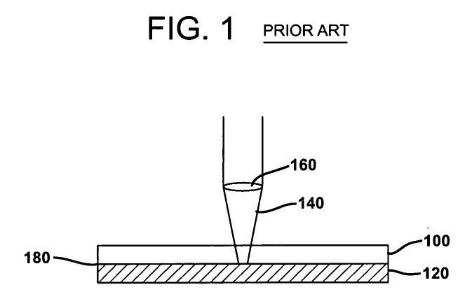

### DETAILED DESCRIPTION OF THE PREFERRED EMBODIMENTS

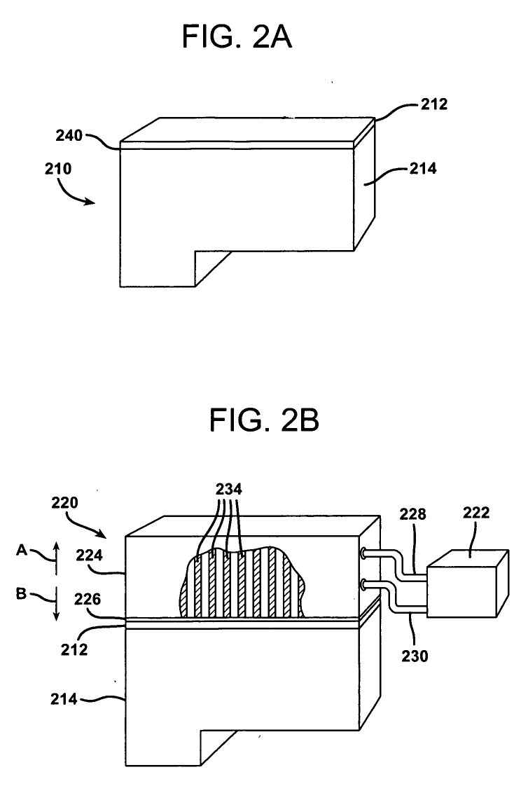

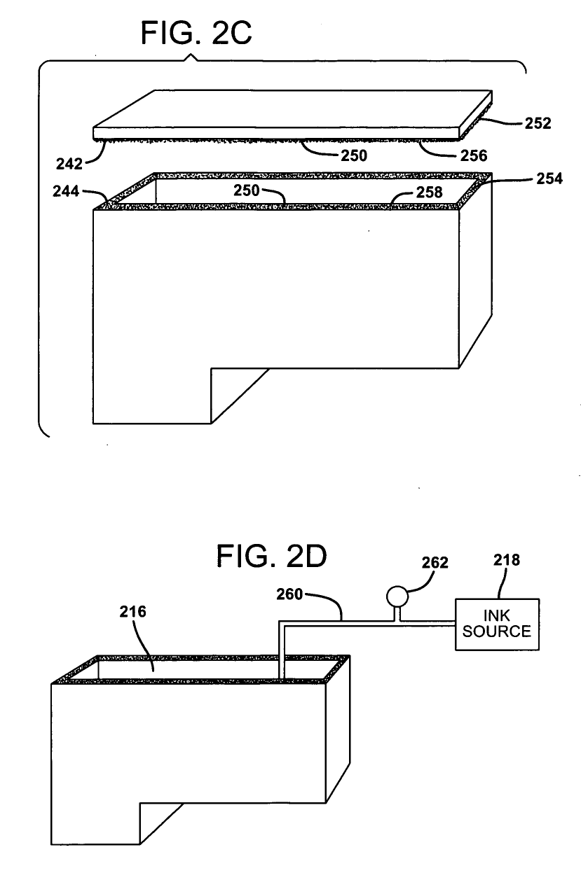

In the following detailed description of the preferred embodiments, reference is made to the accompanying drawings that form a part hereof, and in which is shown by way of illustration, specific embodiments in which the inventions may be practiced. These embodiments are described in sufficient detail to enable those skilled in the art to practice the invention, and it is to be understood that other embodiments may be utilized and that process or other changes may be made without departing from the scope of the present invention. The following detailed description is, therefore, not to be taken in a limiting sense, and the scope of the present invention is defined only by the appended claims and their equivalents. In accordance with the present invention, methods and structures, and the control thereof, are hereinafter described for disassembling inkjet printheads to facilitate repair or refilling. As a preliminary matter, however, the detailed description of the invention includes a reference numeral convention where like elements between the various figures have a first digit corresponding to the figure in which it appears and a following two digits that correspond to one another. For example, the inkjet printhead lid described in the FIGS. 2, 3 and 4 has a reference numeral of 212, 312 and 412, respectively.

With reference to FIGS. 2A-2D, a re-filler or repairer of inkjet printheads will obtain a spent or damaged printhead 210 having external components, such as a lid 212, a body 214, a heater chip and a TAB circuit, and internal components, such as a backpressure device, e.g., a lung or foam. To refill or repair the printhead, a party must first disassemble the printhead into separate components to obtain access to an interior 216 of the printhead for refilling with ink from an ink source 218 or to replace broken or malfunctioning components. In either situation, the present invention contemplates application of heat to one or more of the components to sufficiently destroy the weld or adhesion between the components and allow the separation thereof.

In a preferred embodiment, heat becomes applied through application of laser energy from a laser welding structure 220 having a laser light source 222, a housing 224 and a waveguide 226. Single or multiple lines of control 228, 230 exist between the laser light source and the housing 224 to selectively control the application of laser energy. A special or general purpose computer or other processor (not shown) will provide users with ultimate control of the application of laser light.

In one embodiment, the laser light source represents an 810 nm wavelength Aluminum Gallium Arsenide (AlGaAs) semiconductor laser having a laser power of about 50 watts. In another embodiment, the laser light source embodies other continuous wave lasers with similar power intensity such as semiconductor lasers based on Indium Gallium Arsenide (InGaAs) with wavelengths in a range of about 940-990 nm and Aluminum Gallium Indium Phosphide (AlGaInP) with wavelengths in a range of about 630-680 nm, solid state lasers such as lamp pumped Neodymium-doped Yttrium Aluminum Garnet (Nd:YAG) with a wavelength of 1064 nm and diode pumped Neodymium-doped Yttrium Aluminum Garnet (Nd:YAG) with a wavelength of 1064 nm or other laser diodes or solid state lasers.

The housing 224 has pluralities of fiber optic bundles 234 arranged in desired patterns to illuminate desired areas of the printhead lid with laser light and, ultimately, provide heat to welds and adhesion areas of the printhead. In a preferred embodiment, each bundle has thousands of optical fiber strands therein and laser energy from the laser light source travels to the bundles via the lines of control 228, 230. In other embodiments, the laser energy can travel through an optical path comprised of a lens to focus beams of laser light, as taught in the prior art. Other optical paths may include optical structures such as mirrors, laser scanning devices (e.g., rotating multi-faceted mirrors), other lenses or other.

The waveguide 226 embodies a polycarbonate structure seamlessly, optically, joined to terminal ends of the fiber optic strands of bundles 234 that enables the unimpeded propagation of laser energy from the bundles to the printhead. Other structures may include highly polished metals, glass or mixtures of glass and polycarbonates or other known or hereinafter discovered compositions.

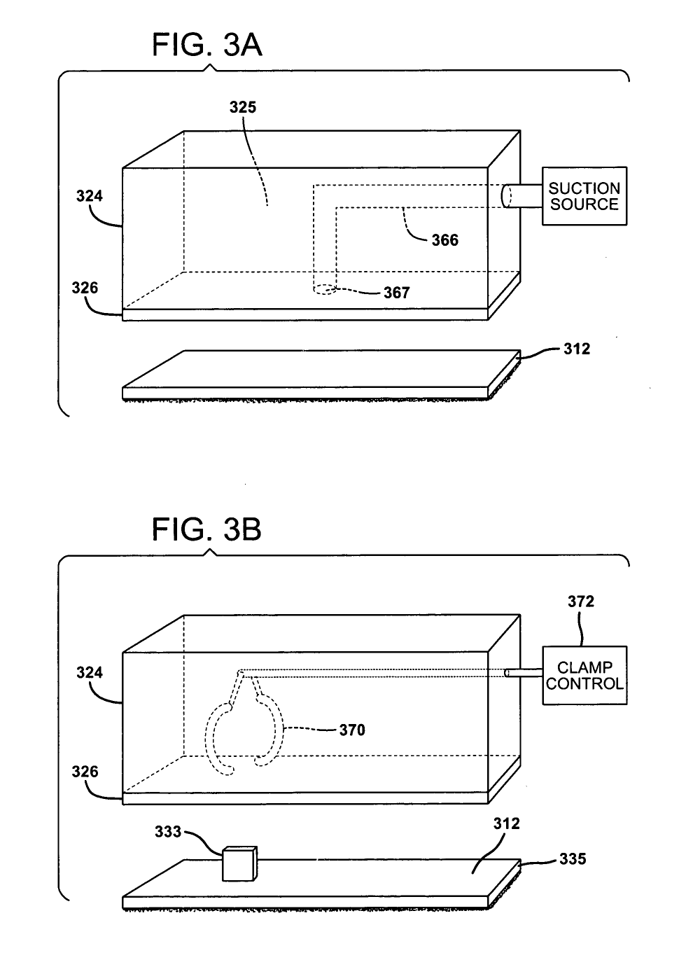

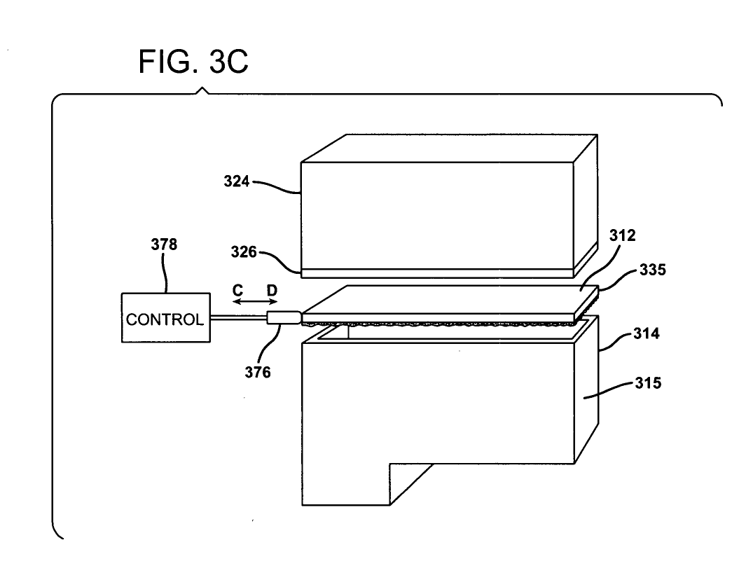

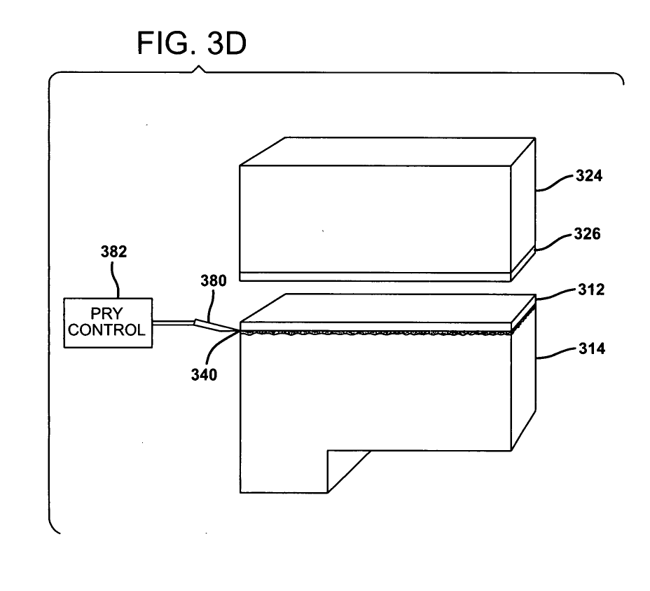

During use, the laser welding structure lowers in the direction of arrow B into close proximity with the lid 212 or onto the lid 212 with some predetermined force. In the event the welding structure touches the lid, when the force increases to the predetermined force, the laser light source turns on and heats the interface 240 between the lid and body for about 0.5 to about 2 seconds and turns it generally molten. In this manner, the heat destroys the weld or adhesion between the lid and body and allows the original alignment there between to become disrupted by whole or partial separation of the components as will be described in various manners below with reference to FIGS. 3A-3D. By lifting the laser welding structure in the general direction of arrow A, an operator can remove the printhead.

Once the components are separated, however, the interface 240 between the lid and body no longer has uniformity. As shown, an undersurface 242 of the lid and an upper surface 244 of the body both have laser welding residue thereon. In particular, each of the undersurface and upper surface has non-uniform, unpredictable or irregular edge lines 252, 254. This is not to say that the valleys 256 and peaks 258 of the edge lines (relative to their respective printhead component, e.g., lid or body) do not generally complimentarily match one another if the two were, in the future, to be placed adjacent to one another. As will be described later, it is this aspect of the invention that can facilitate re-welding of the original lid to the original body. Nonetheless, once separated, the repairers or re-fillers of inkjet printheads may now attend to such repair or refilling. As for repair, in the event the lid or other component was somehow defective or damaged, for example, it can now be replaced with a new lid or new component. Alternatively, for refilling, the interior 216 of the printhead can now have ink replenished therein by connecting an ink source 218 to the interior through piping 260 and suitable controls 262. Typical refilling operations often also include cleaning and removal of the internal backpressure device or other.

Appreciating that the interface 240 between the lid and body will only fleetingly have a molten characteristic, i.e., during the time of receipt of laser energy and a short period of time (seconds) after application thereof, to actually cause whole or partial separate the components from one another, an additional force will be required. FIGS. 3A-3D show some various additional forces contemplated by this invention. In general, the forces include, but should not be limited to, a suction force, a clamping force, a striking force and a prying force.

In FIG. 3A, and appreciating an interior 325 of the housing 324 will likely have space availability, a conduit 366 attaches to a suction source 368 to suck the lid 312 away from the body during the time when their interface has a molten characteristic. Preferably, a terminal end 367 of the conduit presses against the upper surface of the lid or resides in close proximity thereto to lift the lid from the body when the weld or adhesion has been destroyed by application of the laser energy. Other embodiments include an additional or sole suction source applied to the body. The suction source itself may embody a vacuum, a fan/motor pair or other known or hereinafter invented structure for providing suction.

In FIG. 3B, a clamping force becomes applied to the lid by having a caliper 370 grasp a periphery 333 of a keying structure of the lid. A clamp control 372 provides automatic or selective control of the caliper. Other clamping structures include devices that insert into the lid upper surface, devices that grasp the lid periphery 335, expanding fasteners or other known or hereinafter invented structure for providing a clamping force.

In FIG. 3C, a striking or pushing force becomes applied to the lid periphery 335 through application of a striker mechanism 376 that moves into or away from contact with the lid in the direction of arrows C and D. A striker control 378 provides automatic or selective control of the striker mechanism. Other embodiments include additional striker mechanisms for other locations of the lid periphery, striker mechanisms for impacting a body periphery 315 or other known or hereinafter invented structure for providing a striking force. The invention even contemplates pulling forces applied by the striker mechanism.

In FIG. 3D, a prying force becomes applied to the interface 340 between the lid and body to separate the two. Specifically, a pry bar 380 becomes inserted to levy a force on the undersurface of the lid to lift it from the upper surface of the body. A pry control 382 provides automatic or selective control of the pry bar. Other embodiments include additional pry bars which exert force on the lid, the body or both or other known or hereinafter invented structure for providing prying forces.

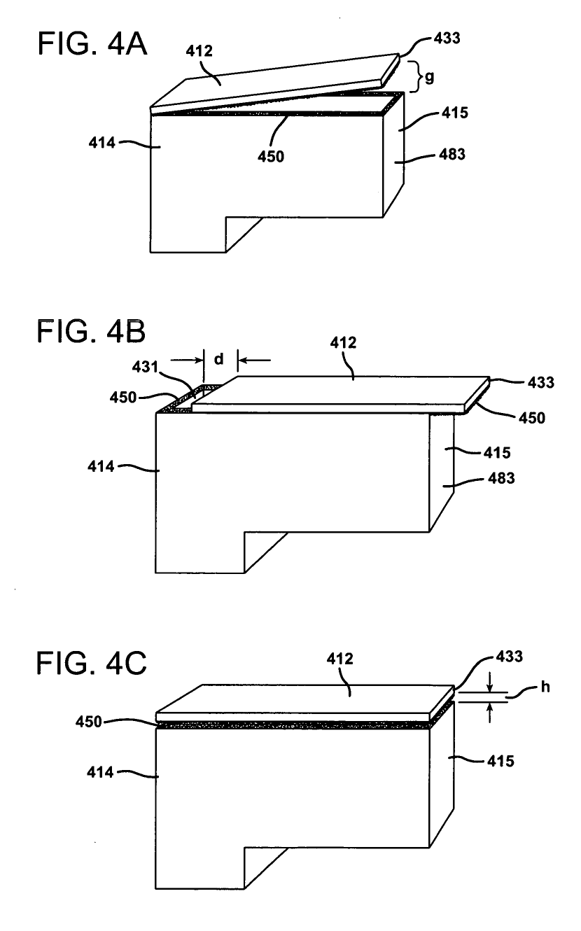

With reference to FIGS. 4A-4C, and by comparison to FIG. 2C, the separation between the inkjet printhead components can embody whole or partial separation. Preferably, the two components become completely separated from one another for unfettered access during refilling, but it is still possible to realize the advantages of the invention with only partial separation of the components. In FIG. 4A, the partial separation between the lid 412 and body 414 represents a lifting of gap, g, distance of the lid periphery 433 relative to the body periphery 415 at a terminal end 483 thereof. In FIG. 4B, the partial separation between the lid and body represents an opening 431 of distance, d, caused by the lid periphery 433 having moved a distance d relative to the body periphery 415 at the terminal end 483 of the printhead. FIG. 4C shows a lid 412 lifted a distance, h, above a body 414 substantially uniformly about the peripheries 433, 415 of each of the lid and body. In all embodiments, however, skilled artisans will appreciate that some quantity of laser welding residue 450 remains on both an upper surface of the body and the undersurface of the lid.

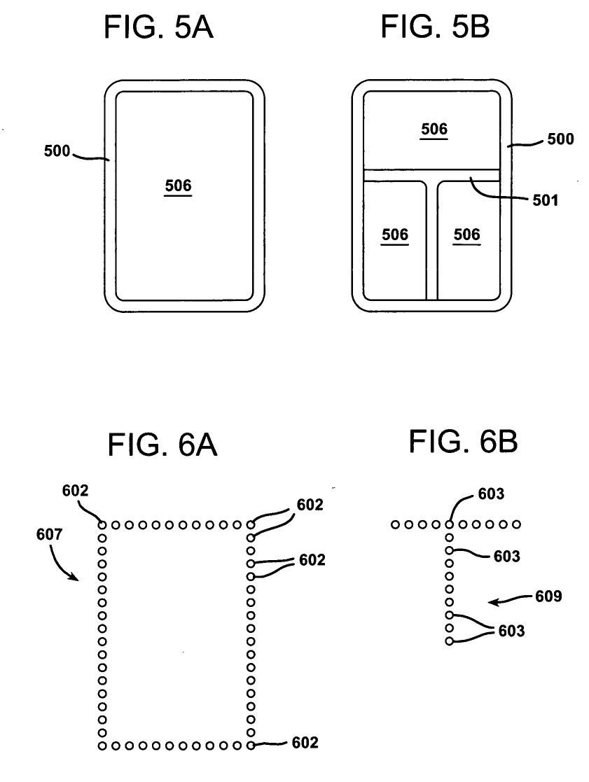

With reference to FIG. 5, since mono ink and color ink inkjet printhead bodies have different internal surfaces which causes manufacturing welding or adhesion to occur at different locations, and since a re-filler or repairer of printheads would suffer inconvenience if required to retool a laser welding structure when disassembling both mono and color bodies, the invention further discloses methods of selectively controlling laser light according to whether the inkjet printhead body embodies a mono or color ink type. In FIG. 5A, the inkjet printhead body type embodies a mono ink cartridge having a perimeter 500 to-be-unwelded surface while in FIG. 5B it embodies a color ink cartridge having a perimeter 500 plus interior 501 to-be-unwelded surface. In particular, the interior has a T-shape that separates three substantially equal volume ink container sections 506 whereas the mono ink embodiment has a single container section 506.

In FIG. 6A, pluralities of laser beam fiber optic bundles 602 (some of the original bundles 234, FIG. 2B) will become controlled such that light will pass through the fiber optic bundles 602 and illuminate an inkjet printhead lid to unweld in a pattern, generally 607, substantially similar in shape to the perimeter 500 to-be-unwelded surface. In FIG. 6B, other pluralities of laser beam fiber optic bundles 603 (others of the original bundles 234, FIG. 2b) will become controlled such that light will pass there through and illuminate an inkjet printhead lid to unweld in a pattern, generally 609, plus pattern 607 together yielding a composite pattern substantially similar to the perimeter 500 plus interior 501 to-be-unwelded surface.

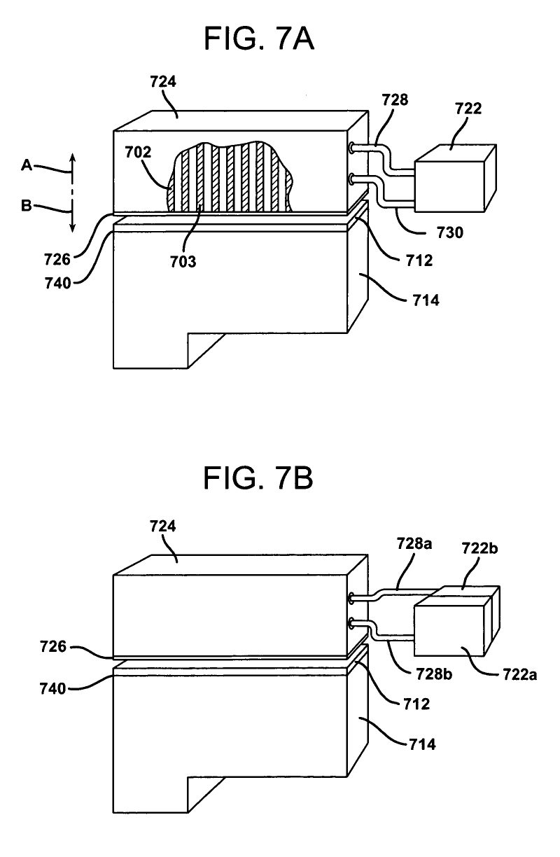

Representative laser welding structures that can accomplish the pattern control of FIGS. 6A, 6B are shown in FIGS. 7A and 7B. Specifically, either one laser light source 722 having two discrete lines of control 728, 730, or two light sources 722a, 722b each having a unique control line 728a, 728b, become controlled such that either the laser beam fiber optic bundles 702 or the laser beam fiber optic bundles 702 together with the laser beam fiber optic bundles 703 illuminate an inkjet printhead lid 712, to unweld the interface 740 in either a pattern substantially similar to the perimeter to-be-unwelded surface or the perimeter plus interior to-be-unwelded surface.

Consequently, a single laser welding structure can shuttle varieties of inkjet body types through the structure and unweld each type without having to retool its basic configuration. As an example, an inkjet printhead lid unwelds from a mono inkjet printhead body with a perimeter to-be-welded surface by illuminating the inkjet printhead lid 712 with pluralities of laser beam fiber optic bundles 702 in a pattern 607 substantially similar to the perimeter to-be-unwelded surface. Thereafter, a disassembly occurs for a color inkjet printhead requiring unwelding of a lid and body with a perimeter plus interior to-be-unwelded surface wherein the lid becomes illuminated through control of the laser light source(s) with pluralities of laser beam fiber optic bundles 702 and 703 in a composite pattern 607 plus pattern 609 together being substantially similar to the perimeter plus interior to-be-unwelded surface of FIG. 5B. Those skilled in the art, however, should appreciate that this invention has utility beyond the patterns shown and may extend to any pattern, line, shape or other.

Once refilled or once a damaged component becomes replaced with a new one, the inkjet printhead requires reassembly. In a preferred embodiment, reassembly occurs in a manner substantially similarly to those techniques described in the prior art. In other embodiments, reassembly occurs, for example, by mating the non-uniform edge lines of the lid and body together and rewelding them. In one instance the rewelding can be via ultrasonic welding, in another instance the welding can be via laser welding in the exact same structure responsible for laser unwelding. By incorporation by reference, the specifics of laser welding and assembly can be found in the applicant's co-pending application entitled “Laser Welding Methods and Structures and Control Therefor Including Welded Inkjet Printheads,” having attorney docket number 2002-0185.02, filed on Nov. 19, 2002 and having Ser. No. 10/299,792.

Although the specifics of inkjet printhead disassembly from teachings above have utility in re-filling or repairing inkjet printheads formed from any manufacturing process, the present invention certainly has more success and applicability when the inkjet printhead to-be-repaired or refilled was originally formed by laser welding. As such, the to-be-disassembled inkjet printhead components preferably embody laser welding compatible components. For example, the component or first work piece that receives direct application of laser light will embody a laser light transparent material while the other component or a second work piece will embody a laser light opaque or absorbing material. In this manner, a beam of laser light can transit the first work piece to unweld the first work piece from the second work piece at the weld interface. Since the second work piece is laser light absorbent, as the beam passes through the first work piece it gets absorbed by the lower work piece and heats the weld interface. Eventually the materials of the first and second work piece become molten thereby facilitating their separation.

The transparency or opaqueness of these components or work pieces, however, does not mean that 100% laser light gets transmitted or blocked. The transparency and opacity is only required to allow enough light to transit the first work piece and get absorbed by the second work piece to form an appropriate amount of molten material to allow separation of the components. A preferred satisfactory rate of transmission of laser light for the first work piece includes rates above about 50%. A more preferred rate includes rates above about 80%. Those skilled in the art know that numerous parameters contribute to the rate of transmission and include, among others, laser wavelength, incident angle of the laser beam, surface roughness of the work piece, temperature of the work pieces, thickness/dimensions of the work piece, composition of the work piece and, in the instance when the work pieces comprise plastics, additives such as flame retardants, plasticizers, fillers and colorants.

Preferred compositions of inkjet printhead components include plastics having a polyphenolynether plus polystyrene blend. Regarding further compositions, the first work piece (e.g., inkjet printhead lid) is preferably substantially entirely transparent and may comprise a polyphenylene ether plus polystyrene (PPE/PS) blend such as that found in Noryl brand SE1 resin. Compositions of the second work piece (e.g., inkjet printhead body), on the other hand, include compositions of, but are not limited to, general purpose polystyrene, high impact polystyrene, such as styrene-butadiene copolymers (CBC), styrene-acrylic copolymers (SMMA). Still others include polyesters and polyester blends including polyethylene terephthalate (PET), polybutylene terephthalate (PBT), as well as blends of these plus polycarbonate (PC), acrylonitrile styrene acrylic (ASA) or other resins or other. When the second work piece is of a PET composition, preferred first work piece component compositions include the foregoing and/or may additionally include copolyesters, glycol modified PET (PETG), glycol modified polycyclohexylenemethylene terephthalate (PCTG), and acid modified PCT (PCTA) or other. Even further, the first work piece may comprise materials having low loading levels of glass fiber such as natural PET (15% glass fiber) or blends of polyester types. Still other compositions include PC/PCTG, PC/PBT, PC/PET, PBT/PETG, PET/PBT, although these sometimes require laser power adjustment when unwelding from polyester inkjet printhead bodies. In still other embodiments, lids can embody PBT/ASA while bodies can embody materials such as styrene methyl methacrylate (SMMA), and styrene acrylonitrile (SAN). Bear in mind, compatibility with inks can also be considered when assessing the compositions of lids and bodies or other components.

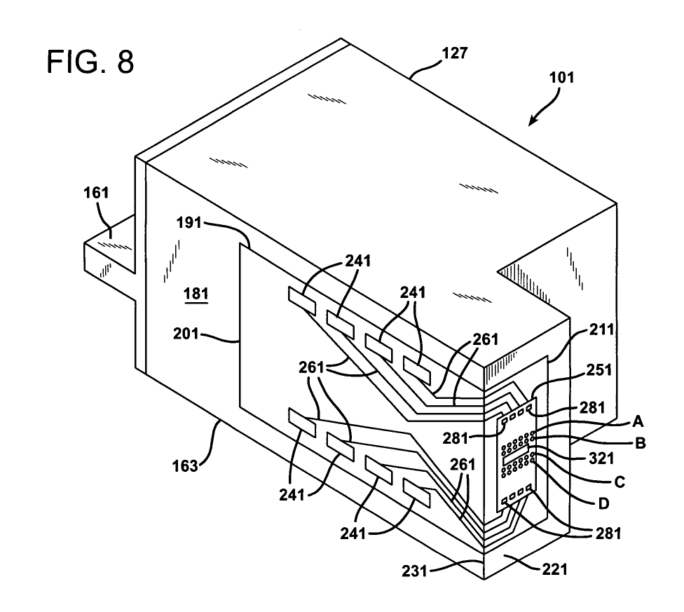

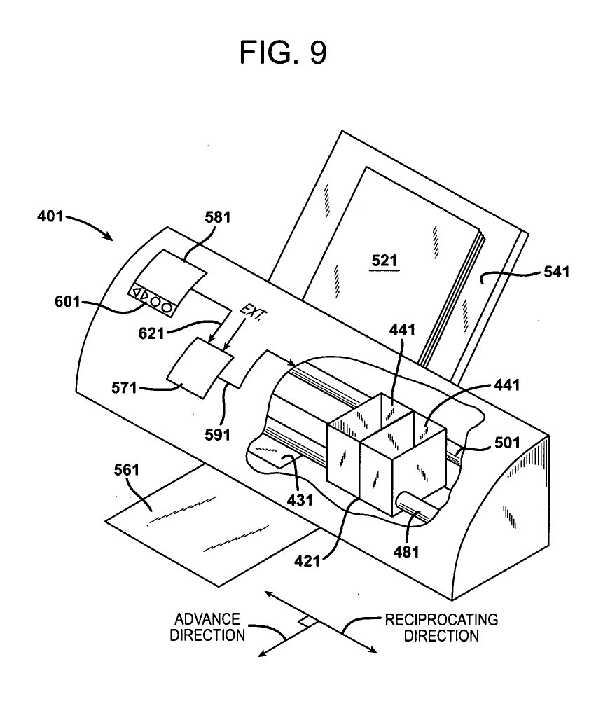

Ultimately, the refilled or repaired inkjet printhead is ready for application back in a printer for example. With reference to FIGS. 8 and 9, and with no additional adherence to the reference numeral convention of FIGS. 2-7, other functional aspects of a reassembled inkjet printhead and the printer that uses them are described. In particular, with reference to FIG. 8, a printhead according to one embodiment of the present invention is shown generally as 101. The printhead 101 has a housing 127 formed of a lid 161 and a body 163 reassembled together. The shape of the housing varies and depends upon the external device that carries or contains the printhead, the amount of ink to be contained in the printhead and whether the printhead contains one or more varieties of ink. In any embodiment, the housing has at least one compartment, internal thereto, for holding an initial or refillable supply of ink and a structure, such as a foam insert, lung or other, for maintaining appropriate backpressure in the inkjet printhead during use. In one embodiment, the internal compartment includes three chambers for containing three supplies of ink, especially cyan, magenta and yellow ink. In other embodiments, the compartment may contain black ink, photo-ink and/or plurals of cyan, magenta or yellow ink. It will be appreciated that fluid connections (not shown) may exist to connect the compartment(s) to a remote source of ink.

A portion 191 of a tape automated bond (TAB) circuit 201 adheres to one surface 181 of the housing while another portion 211 adheres to another surface 221. As shown, the two surfaces 181, 221 exist perpendicularly to one another about an edge 231.

The TAB circuit 201 has a plurality of input/output (I/O) connectors 241 fabricated thereon for electrically connecting a heater chip 251 to an external device, such as a printer, fax machine, copier, photo-printer, plotter, all-in-one, etc., during use. Pluralities of electrical conductors 261 exist on the TAB circuit 201 to electrically connect and short the I/O connectors 241 to the bond pads 281 of the heater chip 251 and various manufacturing techniques are known for facilitating such connections. It will be appreciated that while eight I/O connectors 241, eight electrical conductors 261 and eight bond pads 281 are shown, any number are embraced herein. It is also to be appreciated that such number of connectors, conductors and bond pads may not be equal to one another.

The heater chip 251 contains at least one ink via 321 that fluidly connects to a supply of ink internal to the housing. During printhead manufacturing, the heater chip 251 preferably attaches to the housing with any of a variety of adhesives, epoxies, etc. well known in the art. As shown, the heater chip contains four rows (rows A-row D) of heaters. For simplicity in this crowded figure, dots depict the heaters in the rows. It will be appreciated that the heaters of the heater chip preferably become formed as a series of thin film layers made via growth, deposition, masking, photolithography and/or etching or other processing steps. A nozzle plate with pluralities of nozzle holes, not shown, adheres over the heater chip such that the nozzle holes align with the heaters.

With reference to FIG. 9, an external device, in the form of an inkjet printer, for containing the printhead 101 is shown generally as 401. The printer 401 includes a carriage 421 having a plurality of slots 441 for containing one or more printheads. The carriage 421 is caused to reciprocate (via an output 591 of a controller 571) along a shaft 481 above a print zone 431 by a motive force supplied to a drive belt 501 as is well known in the art. The reciprocation of the carriage 421 is performed relative to a print medium, such as a sheet of paper 521, that is advanced in the printer 401 along a paper path from an input tray 541, through the print zone 431, to an output tray 561.

In the print zone, the carriage 421 reciprocates in the Reciprocating Direction generally perpendicularly to the paper Advance Direction as shown by the arrows. Ink drops from the printheads are caused to be ejected from the heater chip 251 (FIG. 8) at such times pursuant to commands of a printer microprocessor or other controller 571. The timing of the ink drop emissions corresponds to a pattern of pixels of the image being printed. Often times, such patterns are generated in devices electrically connected to the controller (via Ext. input) that are external to the printer such as a computer, a scanner, a camera, a visual display unit, a personal data assistant, or other.

To print or emit a single drop of ink, the heaters (the dots of rows A-D, FIG. 8) are uniquely addressed with a small amount of current to rapidly heat a small volume of ink. This causes the ink to vaporize in a local ink chamber and be ejected through, and projected by, a nozzle plate towards the print medium.

A control panel 581 having user selection interface 601 may also provide input 621 to the controller 571 to enable additional printer capabilities and robustness.

As described herein, the term inkjet printhead may in addition to thermal technology include piezoelectric technology, or other, and may embody a side-shooter structure instead of the roof-shooter structure shown.

The foregoing description is presented for purposes of illustration and description of the various aspects of the invention. The descriptions are not intended to be exhaustive or to limit the invention to the precise form disclosed. For example, other disassembled components may include laser printheads instead of the described inkjet printhead. Nonetheless, the embodiments described above were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A method of disassembling at least two components of an imaging supply item comprising:
applying laser energy to one of said two components; and
wholly or partially separating said one of said at least two components from the other of said at least two components.

2. The method of claim 1, wherein said wholly or partially separating further includes applying a suction force to a first component of said at least two components.

3. The method of claim 1, wherein said wholly or partially separating further includes applying a clamping force to a first component of said at least two components.

4. The method of claim 3, wherein said applying a clamping force further includes grasping a keying structure of said first component.

5. The method of claim 1, wherein said wholly or partially separating further includes applying a striking force to a first component of said at least two components.

6. The method of claim 5, wherein said applying a striking force further includes pushing a periphery of said first component.

7. The method of claim 1, wherein said wholly or partially separating further includes applying a prying force to a first component of said at least two components.

8. The method of claim 7, wherein said applying a prying force further includes inserting a pry bar between said at least two components.

9. The method of claim 1, wherein said applying laser energy further includes providing a laser light source and controlling said laser light source to illuminate said one of said at least two components in one of a pattern substantially similar to a perimeter to-be-unwelded surface and a perimeter plus interior to-be-unwelded surface.

10. A method of disassembling an ink jet printhead lid laser welded to an inkjet printhead body, comprising:
applying laser energy to one of said lid and body; and
wholly or partially separating said lid from said body.

11. The method of claim 10, wherein said applying laser energy further includes providing a laser light source and controlling said laser light source to illuminate said one of said lid and body in one of a pattern substantially similar to a perimeter to-be-unwelded surface and a perimeter plus interior to-be-unwelded surface.

12. The method of claim 10, wherein said wholly or partially separating further includes one of applying a suction source to said one of said lid and body, applying a clamping force to said one of said lid and body, applying a striking force to said one of said lid and body and applying a prying force to said one of said lid and body.

13. A method of disassembling an ink jet printhead lid laser welded to an inkjet printhead body wherein said lid is laser light transparent and said body is laser light absorbent, comprising:
applying laser energy to said lid; and
wholly or partially separating said lid from said body.

14. The method of claim 13, wherein said applying laser energy further includes illuminating a laser light about a periphery of said lid.

15. The method of claim 13, wherein said applying laser energy further includes illuminating a laser light about a periphery plus interior of said lid.

16. The method of claim 13, wherein said applying laser energy further includes providing a laser light source with one of a single light source having two discrete lines of control and two light sources each having a unique line of control.

17. The method of claim 13, wherein said wholly or partially separating further includes one of applying a suction source to said lid, applying a clamping force to said lid, applying a striking force to said lid and applying a prying force to said lid.

18. The method of claim 13, further including one of welding said lid back to said body and welding a new lid to said body.

19. The method of claim 18, wherein said welding further includes one of laser and ultrasonically welding.

20. In a system for laser welding an inkjet printhead lid and body along a weld interface through application of a first instance of laser energy, the improvement comprising applying a second instance of laser energy to unweld said weld interface.

21. The method of claim 20, further including wholly or partially separating said lid from said body.

22. A method of refilling an inkjet printhead having a lid and body secured to one another, comprising:
applying laser energy to one of said lid and said body; and
refilling said body with ink.

23. The method of claim 22, further including wholly or partially separating said lid from said body.

24. The method of claim 23, wherein said applying laser energy occurs at a weld interface between said lid and body.

25. A method of refilling an inkjet printhead having a lid and body secured to one another, comprising:
heating one of said lid and said body;
wholly or partially separating said lid from said body; and
refilling said body with ink.

26. The method of claim 25, wherein said heating further includes applying laser energy to said one of said lid and said body.

27. The method of claim 26, further including one of welding said lid back to said body and welding a new lid to said body.

28. A method of disassembling at least two components of an inkjet printhead, comprising:
applying laser energy to one of said two components; and
disrupting an original alignment between said two components.

29. The method of claim 28, wherein said disrupting further includes wholly or partially separating one of said two components from the other of said two components.

30. The method of claim 29, further including refilling said one of said two components with ink.

31. The method of claim 29, further including realigning said two components back into said original alignment.

32. The method of claim 31, further including welding said two components.

33. A disassembled inkjet printhead, comprising:
a first component having a first laser welding residue thereon; and
a second component having a second laser welding residue thereon.

34. The disassembled inkjet printhead of claim 33, wherein said first component is an inkjet printhead lid and said second component is an inkjet printhead body.

35. The disassembled inkjet printhead of claim 33, wherein said first laser welding residue has a first non-uniform edge line substantially matching a second non-uniform edge line of said second laser welding residue.

36. A disassembled inkjet printhead, comprising:
a lid with an undersurface having a first laser welding residue thereon; and
a body with an upper surface having a second laser welding residue thereon.

37. A disassembled inkjet printhead, comprising:
a lid with an undersurface having a first non-uniform laser welding residue thereon; and
a body with an upper surface having a second non-uniform laser welding residue thereon.
